(19) United States
(12) Patent Application Publication
(10) Pub. No.: US 2015/0295661 A1
(43) Pub. Date: Oct. 15, 2015

(54) REMOTELY CONTROLLABLE ELECTRONIC DEVICE

(71) Applicant: Wei-Chih HUANG, Taipei City (TW)

(72) Inventor: Wei-Chih HUANG, Taipei City (TW)

(21) Appl. No.: 14/250,457

(22) Filed: Apr. 11, 2014

(51) Int. Cl. H04B 10/67; G08C 23/04

(52) U.S. Cl. CPC H04B 10/676; G08C 23/04

(57) ABSTRACT

A remotely controllable electronic device comprises an infrared receiver and a control unit. The infrared receiver is for wirelessly receiving a first signal and a plurality of control signals. The control unit coupled to the infrared receiver having a look-up table which stores a plurality of specific codes corresponding to a plurality of learning mode signals. The control unit compares the first signal received by the infrared receiver with the specific codes stored in the look-up table. When the first signal is one of the learning mode signals the control unit operates in a learning mode, and the control unit stores the control signals received after receiving the first signal which is one of the learning mode signals. The control unit generates a plurality of function signals. Each function signal is corresponding to one of the control signals received by the infrared receiver in the learning mode.

### BACKGROUND OF THE INVENTION

1. Field of the Invention

The instant disclosure relates to remote control; in particular, to a remotely controllable electronic device.

2. Description of Related Art

The remote control for television is developed in the 1950s. Initially, the remote control is wired to the television. The first wireless remote, introduced in 1955, was called the Flashmatic. The Zenith remote shined highly focused light beams on the receivers located around the screen of the television. At present, many home appliances are able to be controlled by the corresponding remote controls, such as the fans, or the air conditioners. Please refer to FIG. 1 showing a block diagram of a conventional remote control system. A remote control system 1 comprises a dedicated remote control 11 and a remotely controllable electronic device 12. The remotely controllable electronic device 12 comprises a power supply 121, a actuating means 122, a control unit 123, a status indicating unit 12 (e.g., LED shown in FIG. 1), keypad 125, an IR receiver 126 and a power plug 127 The IR receiver 126 receives the IR control signal from the dedicated remote control 11, and then the control unit 123 generates a corresponding function signal to control the actuating means 122. The actuating means 122 is utilized to perform the functions of the controlled electronic device 12. For example, the electronic device 12 may be a lamp or a fan, in which the actuating means 122 would perform the functions of the electronic device 12. For example, when the electronic device 12 is a lamp or a fan, the actuating means 122 may be the lamp driver or the motor of the fan. It is worth mentioning that the power plug 127 is for connecting to a power source (e.g., the city power supply).

As, shown in FIG. 1, the control unit 123 usually has a demodulator circuit 1231, a logical circuit 1232 (e.g., a MCU shown in FIG. 2) and a memory unit 1233. The demodulator circuit 1231 connected to the IR receiver 126 demodulates the IR control signal from the dedicated remote control 11, and the demodulated result is transmitted to the control unit 1232. The logical circuit 1232 executes a function process according to the demodulated result, wherein the logical circuit 1232 may read the memory unit 1233 to perform the corresponding functions.

However, each electronic device usually has its dedicated remote control; therefore many remote controls could exist in each family for everyday life. The user needs to utilize the dedicated remote control to control the corresponding electronic device, which is not convenient for the user. Furthermore, the manufactures of the electronic devices need to design the dedicated remote controls corresponding to their electronic products, and the related cost of the remote controls may not be saved.

### SUMMARY OF THE INVENTION

The object of the instant disclosure is to offer a remotely controllable electronic device which could be remotely controlled by any infrared remote controller.

In order to achieve the aforementioned objects, according to an embodiment of the instant disclosure, a remotely controllable electronic device is provided. The remotely controllable electronic device comprises an infrared receiver and a control unit. The infrared receiver is for wirelessly receiving a first signal and a plurality of control signals. The control unit is coupled to the infrared receiver for receiving the first signal and the plurality of control signals from the infrared receiver. The control unit has a look-up table storing a plurality of specific codes corresponding to a plurality of learning mode signals. The control unit compares the first signal received by the infrared receiver with the specific codes stored in the look-up table. When the first signal is one of the learning mode signals the control unit operates in a learning mode, and the control unit stores the control signals received after receiving the first signal which is one of the learning mode signals. The control unit is for generating a plurality of function signals. Each function signal is corresponding to one of the control signals received by the infrared receiver in the learning mode.

In summary, the remotely controllable electronic device could start the learning mode when the first signal received by the infrared receiver is one of the learning mode signals (i.e. determines whether any learning mode signal is received). After the learning process being executed in the learning mode, the control unit of the remotely controllable electronic device could store the received control signals for corresponding to a plurality of function signals. Thus, the user could use any infrared remote control to control the remotely controllable electronic device, and the related cost of the dedicated remote control of the electronic device could be saved accordingly.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a block diagram of a conventional remote control system;

FIG. 2 shows a block diagram of a remote control system according to an embodiment of the instant disclosure;

FIG. 3A shows the protocols of corresponding remote controls for the look-up table according to an embodiment of the instant disclosure;

FIG. 3B shows the correspondences between the functions of the electronic device and the learned IR control signals according to an embodiment of the instant disclosure;

FIG. 4 shows a block diagram of a remote controllable device according to an embodiment of the instant disclosure; and

FIG. 5 shows a flow chart of a remote controllable device according to an embodiment of the instant disclosure.

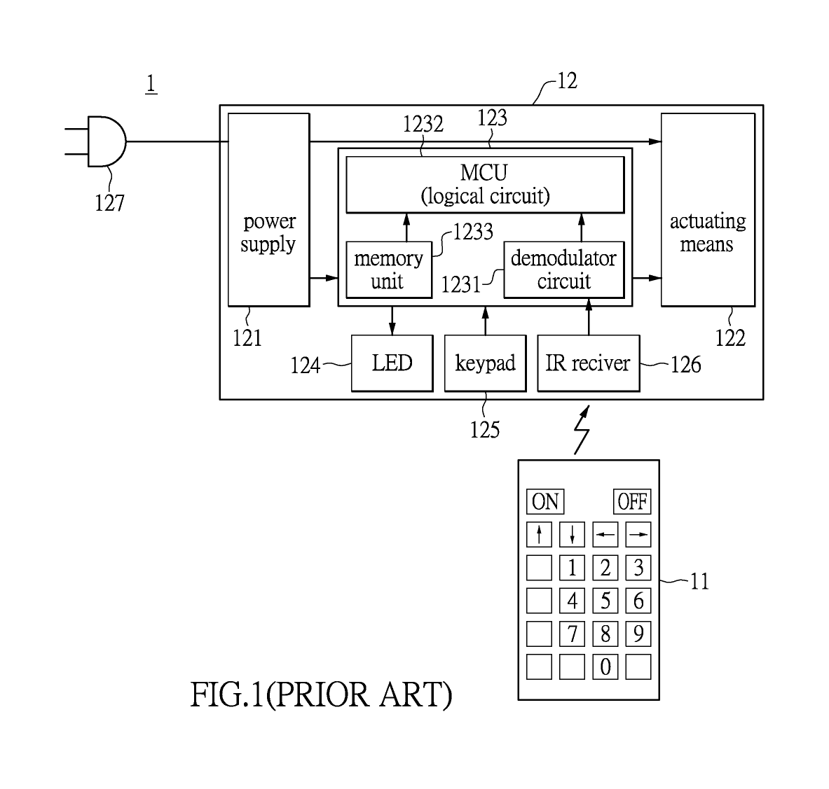

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

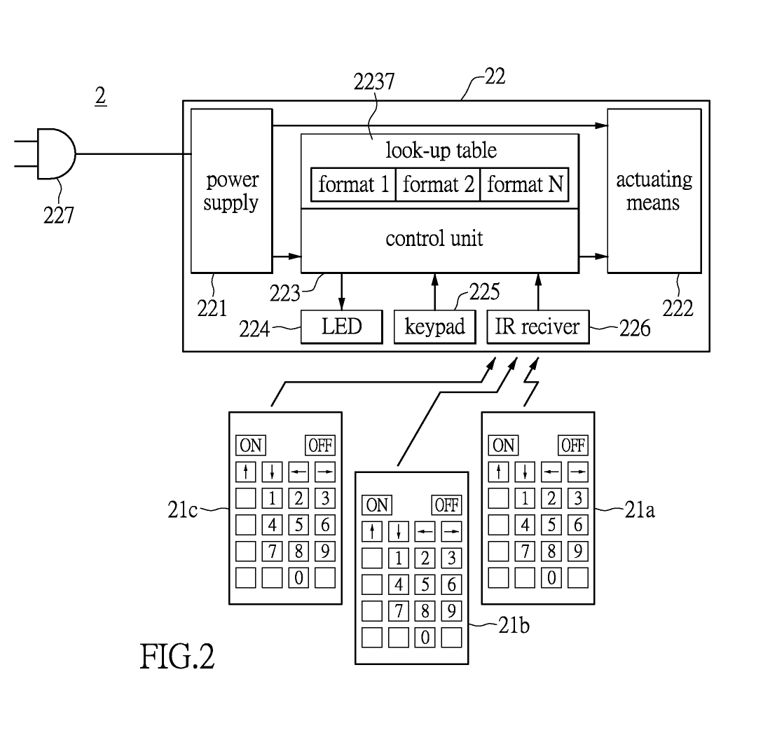

Please refer to FIG. 2 showing a block diagram of a remote control system according to an embodiment of the instant disclosure. A remote control system 2 comprises remote controls 21a, 21b and 21c and a remotely controllable electronic device 22. Differing from the conventional dedicated remote control 11 disclosed in the related art, each of the remote controls 21a, 21b and 21c may be any IR remote control for any brand (or any kind) of home appliance. The remotely controllable electronic device 22 could enter a learning mode to learn the IR controls signals of any IR remote control (21a, 21b or 21c). Specifically, the remotely controllable electronic device 22 comprises a power supply 221, an actuating means 222, an infrared (IR) receiver 226, a control unit 223, a status indicating unit 224, a keypad 225 and a power plug 227. The infrared receiver 226 is for wirelessly receiving a first signal and a plurality of control signals. The control unit 223 is coupled to the infrared receiver 226 for receiving the first signal and the plurality of control signals from the infrared receiver 226. It is worth mentioning that the transmitting source of the first signal for entering the learning mode and the transmitting source of the control signals to be learned in the learning mode may be different.

The power supply 221 is connected to the power source through the power plug 227. The power supply 221 may be an AC-DC converter. The control unit 223 is coupled to the infrared receiver 226, the power supply 221, the status indicating unit 224, the keypad 225 and the actuating means 222. The power supply 221 provides electricity to the control unit 223 and the actuating means 222. The remotely controllable electronic device 22 may be a lamp, a fan, a stereo set, a washing machine or an oven. The keypad 225 coupled to the control unit may control the functions of the remotely controllable electronic device 22.

The control unit 223 has a look-up table 2237 storing a plurality of specific codes corresponding to a plurality of learning mode signals. The infrared protocols for the control signals of the remote controls 21a, 21b and 21c may difference according to the manufacturers of the remote controls 21a, 21b and 21c and the types of home appliance corresponding to the remote controls 21a, 21b and 21c. For example, the infrared protocol may comprises at least one protocol selected from a group of protocols consisting of a NEC protocol, a Philips protocol, an RC-5 protocol, an RC-6 protocol, an RC-MM protocol and a Toshiba protocol. However, this shouldn't be the limitation to the present invention.

The number of specific codes stored in the look-up table 2237 is not for restricting the scope of the present invention. For example, three specific codes comprising format 1, format 2 and format N would be described for ease of explanation. Alternatively, more or fewer (at least two) specific codes could be stored in the look-up table 2237, the specific codes may comprises format 1, format 2 . . . format N, wherein the format N is the last specific codes, N is a natural number. Each of the specific code may be corresponding to an infrared protocol. Each of the specific code stored in the look-up table 2237 may comprises a customer code, thus each specific code may at least corresponding to at least one kind of the home appliance of at least one manufacturer. In this embodiment, the specific codes of format 1 may corresponding to one of the infrared control signals transmitting from the remote control 21a, the specific codes of format 2 may corresponding to one of the infrared control signals transmitting from the remote control 21b, and the specific codes of format N may corresponding to one of the infrared control signals transmitting from the remote control 21c.

The first signal may be one of the learning mode signal or other irrelevant signal. The control unit 223 could compares the first signal received by the infrared receiver 226 with the specific codes stored in the look-up table 2237. The first signal is the learning mode signal when the decoded first signal is match with a specific code stored in the look-up table 2237. When the first signal is one of the learning mode signals the control unit 223 operates in a learning mode, and the control unit 223 stores the control signals which are received after receiving the first signal which is one of the learning mode signals. The control unit 223 is for generating a plurality of function signals. Each function signal is corresponding to one of the control signals received by the infrared receiver 226 in the learning mode. Details of the control unit 223 would be described in the follows.

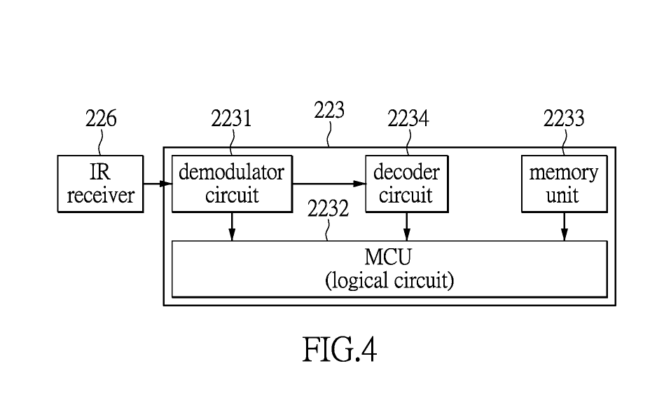

FIG. 4 shows a block diagram of a remote controllable device according to an embodiment of the instant disclosure. The control unit 223 comprises a demodulator circuit 2231, a decoder circuit 2234, a memory unit 2233 and a logical circuit 2232 (e.g., the MCU shown in FIG. 4). The demodulator circuit 2231 is coupled to the infrared receiver 226 for demodulating the first signal and the plurality of control signals received by the infrared receiver 226. The logical unit 2232 compares the first signal and the specific codes in the look-up table 2237 for identifying whether the received first signal is one of the learning mode signals. For example, the learning mode signal may be any IR signal from any IR remote control (21a, 21b or 21c), and the control signals may be other functional signals form from any IR remote control (21a, 21b or 21c), but the present invention is not so restricted. The first signal may be any control signal of any remote control (21a, 21b or 21c), in order to comparing the first signal with the specific codes in the look-up table 2237 for identifying the remote control generating the first signal. If the received first signal is one of the learning mode signals, then any other control signals could be learned (memorized in the memory unit 2233) in the learning mode. That is, the user can use one remote control (e.g. the remote control 21a) to transmit the first signal for entering the learning mode, and use another remote control (e.g. the remote control 21b or 21c) to transmit the control signals which is intended to be learned in the learning mode. The remotely controllable electronic device 22 doesn't not need to distinguish whether the learning mode signal and the control signals to be learned are from the same remote control or not. The decoder circuit 2234 is coupled to the demodulator circuit 2231 for receiving the demodulated control signals in order to decode the first signal and the control signals. Because the remote control 21a, 21b or 21c may be any remote control dedicated to any home appliance made by any manufacturer, the decoder circuit 2234 may decode the demodulated control signal according to the IR protocol such as NEC, Philips, RC5, RC6, RC-MM, Toshiba, . . . etc.

Compared to the conventional control unit 123, the control unit 223 of the present disclosure could decodes a plurality of IR protocols applied to the remote controls 21a, 21b and 21c, which means the remote control may be changed. When the remote control (e.g., the remote control 21a) is changed to another remote control (e.g., the remote control 21b or the remote control 21c), it only has to perform the learning mode again for dedicating the another remote control (e.g., the remote control 21b or the remote control 21c) to the electronic device 22. In other words, any IR remote control could be the dedicated remote control of the electronic device 22.

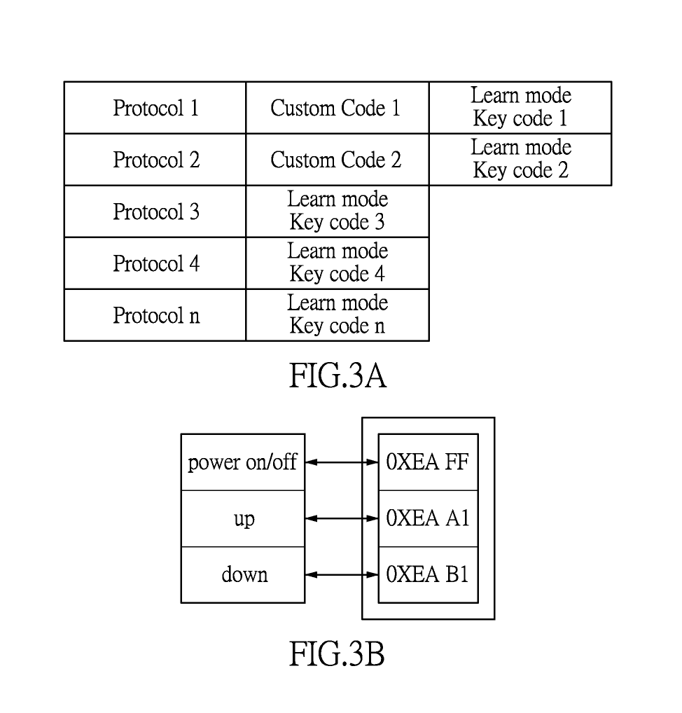

For example, FIG. 3A shows protocols of corresponding remote controls according to an embodiment of the instant disclosure. For a first example, the code of the learning mode signal may start with a protocol 1 (e.g. NEC protocol, Philips protocol . . . ), following with a custom code 1 (e.g. manufacturer's code representing the manufacturer of the remote control such as SONY, SHARP . . . etc.), and following with a learn mode key code 1. For a second example, the code may start with a protocol 2 following with a custom code 2, and following with a learn mode key code 2. For a third example, the code may start with a protocol 3 following with a learn mode key code 3 only. For a fourth example, the code may start with a protocol 4 following with a learn mode key code 4 only. For still another example, the code of the learning mode signal may start with a protocol “n” (in which n is an integer) following with a learn mode key code “n” only. Each of the protocols (e.g. protocol 1, protocol 2, protocol 3, protocol 4 and protocol “n”) may be one of the NEC, Philips, RCS, RC6, RC-MM, and Toshiba protocols, for example, but the instant disclosure is not so restricted. The utilized protocol is selected (or defined) by the manufacturer of the remote control, and the custom code may be defined by the manufacturer of the remote control too. In which, the control unit 223 could decode the protocol of the learning mode signal and identify whether the codes of the received IR signal comprises any of the specific codes (i.e. learn mode key codes) pre-stored in the look-up table of the control unit 223.

The learn mode key code may be any one control signal selected from all control signals of the remote control. In one embodiment, for example, the learn mode key code may be a record key of the TV remote control originally for transmitting a record signal to the TV. The record signal transmitted from any remote control with decodable protocols (i.e. decodable by the control unit 223) may be defined as one of the learning mode signals. Alternatively, the learn mode key code may be pre-defined by a manufacturer (X1) of the electronic device 22. And any other manufacturers (X2) of the remote controls just needs to design one learning mode key on each manufactured remote control for enabling to transmit the learn mode key code which is pre-stored in look-up table 2237 of the control unit 223 in the electronic device 22.

Therefore, the manufacturer of the electronic device 22 does not need to manufacture any dedicated remote control for the electronic device 22. Any IR remote control of any other electronic device could be the dedicated remote control of the electronic device 22 when the decoder circuit 2234 could be applied to decode the IR remote control of any other electronic device. For example, one remote control of the fan made by the manufacturer A1 or another remote control of the lamp made by the manufacturer B2 could be applied to control the electronic device 22 (e.g., a fan), as long as the decoder circuit 2234 could decode the IR protocols used by the manufacturers A1 and B2.

The memory unit 2233 stores specific codes (which are the learn mode key codes shown in FIG. 3A) for identifying learning mode signals. Further, the memory unit 2233 also stores the learning result made by the logical circuit 2232 in the learning mode. In detail, in the learning mode, the memory unit 2233 may stores matching table which records the correspondence between the received IR signals and the functions. And, more than two remote controls could be configured to be the dedicated remote control according to the memory size of the memory unit 2233. The number of specific codes stored in the look-up table 2237 restricts the number of kinds of the remote controls which could start the learning mode. The number of remote controls which could be set as the dedicated remote controls depends on the size of the memory unit 2233. FIG. 3B shows the correspondences between the functions of the electronic device and the learned IR control signals according to an embodiment of the instant disclosure. In this embodiment, the electronic device 22 has three default functions including power on/off, speed-up, and slow-down. In the learning mode, the code “0XEA FF” of one control signal is correspondence to the function of power on/off. The code “0XEA A1” of another control signal is correspondence to the function of speed up. The code “0XEA A2” of still another control signal is correspondence to the function of speed down.

The logical circuit 2232 is coupled to the decoder circuit 2234 and the memory unit 2233 for storing the decoded control signals to the memory unit 2233 when the logical circuit 2232 receives the learning mode signal. The logical circuit 2232 itself may be a microprocessor or a logical circuit made by several logic gates, the present disclosure does not limit the implementation manner of the logical circuit 2232.

In the learning mode, the control unit 223 may sequentially memorize the received and decoded IR control signal to the memory unit 2233 of the control unit 223. For example, if the electronic device 22 is a fan which has the functions of power on/off, speed-up, and slow-down, the user needs to use the remote control 21a (21b or 21c) to turn on/off the fan and switch the speed of the fan. A first button of the remote control 21a (21b or 21c) shall be defined as the power button of the fan, a second button of the remote control 21a (21b or 21c) may be defined as the speed-up button, and a third button of the remote control 21 may be defined as the slow-down button. The control unit 223 of electronic device 22 may be designed to memorize the first received IR control signal as the power on/off function, the second received IR control signal as the speed-up function and a third received IR control signal as the slow-down function in the learning mode. When the learning mode is started the status indicating unit 224 (i.e. LED) could display a preset light, such as a flashing red light. Then, the user could press the first button of the remote control 21a (21b or 21c) to send the first IR control signal, and the control unit 223 memorizes the received first IR control signal as the power on/off function. And, the user may further press the second button of the remote control 21a (21b or 21c) to send the second IR control signal for memorizing the second IR control signal as the speed-up function by the control unit 223. Then, the user may further press the third button of the remote control 21a (21b or 21c) to send the third IR control signal for memorizing the third IR control signal as the slow-down function by the control unit 223. After the control unit 223 sequentially memorized the received IR signals, the pressed buttons of the remote control 21a (21b or 21c) in the learning mode have been defined as the corresponding functions of the electronic device 22. The remote control 21a (21b or 21c) has already been the dedicated remote control of the electronic device 22. In practical applications, the user could use a remote control of other home appliance to control the electronic device 22, in which the user could define the rare used buttons of the remote control to control the electronic device 22. However, the user may define any button of the remote control 21a (21b or 21c) according to personal habits. Additionally, the memory unit 2233 may memorize more than one set of the IR control signals. The memory unit 2233 may memorize the IR control signals of a remote control X1 in a learning mode. Then, another user may start the learning mode again and use a remote control X2 to send another set of IR control signals to the electronic device 22. Two or more remote controls could be dedicated to control the electronic device 22.

Furthermore, the electronic device 22 operates in a normal mode when the control unit 223 does not receive the learning mode signal, and the logical circuit 2232 generates one of the function signals corresponding to the decoded IR control signal stored in the memory unit 2233 when the electronic device 22 receives the corresponding control signal learned in the normal mode. More specifically, in the normal operation, when the electronic device 22 receives the IR control signal, the decoder circuit 2234 decodes the IR control signal then logical circuit 2232 determines whether the received IR control signal is the learned control signal in the learning mode. If the received IR control signal is the learned control signal, the control unit 223 controls the actuating means 222 to perform the corresponding function, such as altering the speed of the fan, or turning on/off the fan (i.e. the electronic device 22).

Alternatively, in one embodiment, the learning mode may be executed in the following process. When the learning mode signal is received the learning mode is executed. Then the logical circuit 2232 waits to receive and store the control signal coming from the remote control 21a (21b or 21c) to the memory unit 2233. The received and stored control signals could be set corresponding to the functions of the functional keys of the keypad 225. For example, in the learning mode, when a first functional key of the electronic device 22 is pressed the logical circuit 2232 then waits to receive and store a IR control signal for corresponding to the first functional keys of the key pad 225. The user may press a first button of the remote control (maybe the remote control which had transmitted the learning mode signal to the electronic device 22 or any other remote control, it means that the remote control transmitting the learning mode signal and the remote control transmitting the control signal for being memorized may not the same remote control) to transmit the IR control signal to the electronic device 22 for storing in the memory unit 2233 and corresponding to the first functional key. Then, if the user needs to make the correspondence of a second function of a second functional key (e.g., speed up key) and a second button of the remote control, the user could press the second functional key of the electronic device 22 then press a second button of the remote control to generate a second IR control signal. Accordingly, a number of buttons of the remote control could be defined as the functional keys of the electronic device 22 for remotely control. In another embodiment, in the learning mode, the logical circuit 2232 waits to sequentially receive and store a plurality of IR control signals for corresponding to functional keys of the key pad 225, in which the user does not need to press any button of the electronic device 22 and the logical circuit 2232 could be designed to sequentially storing received IR control signals to the memory unit 2233 (, and each of the received IR control signal may be corresponding to one of the function of the functional keys of the key pad 225). Thus, the remote control 21a (21b or 21c) could be the dedicated remote control of the electronic device 22 accordingly.

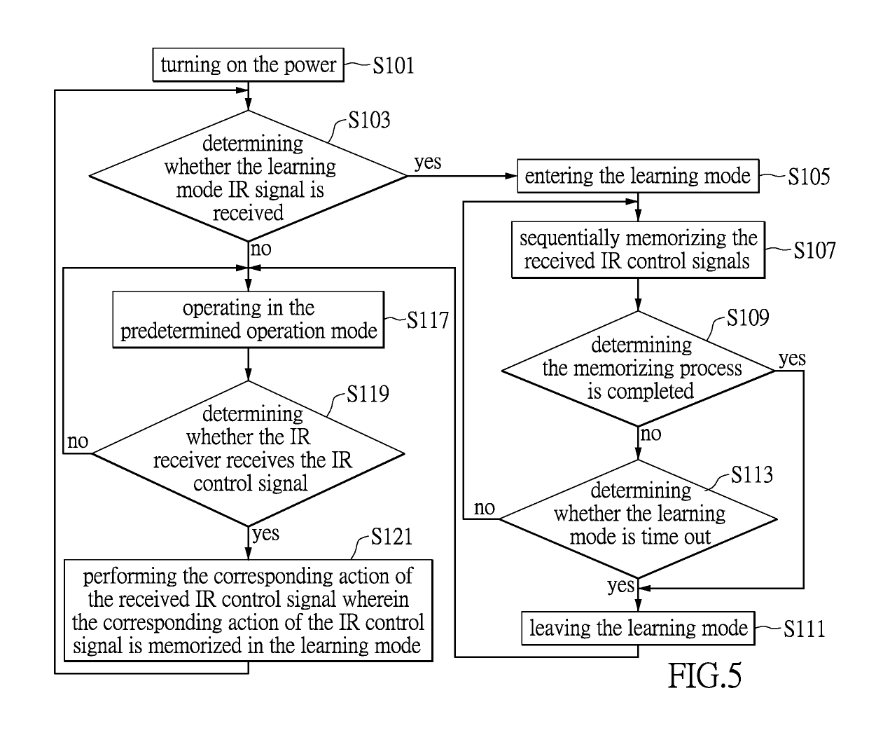

Please refer to FIG. 2 in conjunction with FIG. 5, FIG. 5 shows a flow chart of a remote controllable device according to an embodiment of the instant disclosure. First, in step S101, turning on the power. The user may connect the power plug or turn on the power switch of the electronic device 22. Then, in step S103, the control unit 223 determines whether the learning mode IR signal is received or not. If the learning mode IR signal is received, then go to step S105, otherwise go to step S117. In step S105, the electronic device 22 enters the learning mode. Then, in step S107, the control unit 223 sequentially memorizes the received IR control signals. Then, in step S109, the control unit 223 determines the memorizing process is completed or not. If the memorizing process is completed, go to step S111, otherwise go to step S113. In step S111, leaving the learning mode. In step S113 determining whether the learning mode is time out or not. If the learning mode is time out, go to step S111, otherwise go to step S107 again. If the learning mode IR signal is not received, then step S117 is executed to operate in the predetermined operation mode which is the normal operation of the electronic devices 22. Then, in step S119, the control unit 223 determines whether the IR receiver 226 receives the IR control signal. If the IR control signal is received, then performs step S121, otherwise performs step S117 continually (i.e., step S117 is continually executed). In step S121, the electronic device 22 performs the corresponding action of the received IR control signal wherein the corresponding action of the IR control signal is memorized in the learning mode in advance. After step S121, executing step S103 again. The flow chart of the operation of the electronic device 22 is only for describing the operation of the electronic device 22 in an understandable and clear way, but the present invention is not so restricted.

According to above descriptions, this instant disclosure provides a remotely controllable electronic device which could be remotely controlled by any infrared remote controller. The remotely controllable electronic device determines whether any learning mode signal is received. The remotely controllable electronic device could start the learning mode to store the control signals of the remote control when receiving a learning mode signal from any infrared remote control. After the learning process executed in the learning mode, the remotely controllable electronic device could be control by the control signals of the corresponding infrared remote control. Thus, the user could use any infrared remote control to control the remotely controllable electronic device, and the related cost of the dedicated remote control of the electronic device could be saved accordingly.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A remotely controllable electronic device, comprising:
an infrared receiver, for wirelessly receiving a first signal and a plurality of control signals; and
a control unit, coupled to the infrared receiver, receiving the first signal and the plurality of control signals from the infrared receiver, having a look-up table storing a plurality of specific codes corresponding to a plurality of learning mode signals, comparing the first signal received by the infrared receiver with the specific codes stored in the look-up table, operating in a learning mode when the first signal is one of the learning mode signals, and storing the control signals received after receiving the first signal which is one of the learning mode signals, wherein the control unit is for generating a plurality of function signals, each function signal is corresponding to one of the control signals received by the infrared receiver in the learning mode.

2. The remotely controllable electronic device according to claim 1, wherein the control unit comprises:
a demodulator circuit, coupled to the infrared receiver, demodulating the first signal and the plurality of control signals received by the infrared receiver;
a decoder circuit, coupled to the demodulator circuit, receiving the demodulated first signal and control signals, decoding the first signal and the control signals;
a memory unit; and
a logical circuit, coupled to the decoder circuit and the memory unit, comparing the first signal received by the infrared receiver with the specific codes stored in the look-up table, wherein the first signal is the learning mode signal when the decoded first signal is match with a specific code stored in the look-up table, the logical circuit stores the decoded control signals to the memory unit in the learning mode.

3. The remotely controllable electronic device according to claim 2, wherein the remotely controllable electronic device operates in a normal mode when the control unit does not receive the learning mode signal, the logical circuit generates one of the function signals corresponding to the decoded control signal stored in the memory unit when the remotely controllable electronic device receives the corresponding control signal in the normal mode.

4. The remotely controllable electronic device according to claim 1, wherein each of the specific code comprises a customer code.

5. The remotely controllable electronic device according to claim 1, wherein each of the specific code is corresponding to an infrared protocol.

6. The remotely controllable electronic device according to claim 5, wherein the infrared protocol comprises at least one protocol selected from a group of protocols consisting of a NEC protocol, a Philips protocol, an RC-5 protocol, an RC-6 protocol, an RC-MM protocol and a Toshiba protocol.

7. The remotely controllable electronic device according to claim 1, wherein the control unit is a microprocessor.

8. The remotely controllable electronic device according to claim 1, wherein the logical circuit is a microprocessor or made of a plurality of logic gates.

9. The remotely controllable electronic device according to claim 1, further comprises a power supply connected to the power source, the power supply is coupled to the control unit.

10. The remotely controllable electronic device according to claim 9, wherein the power supply is an AC-DC converter.

11. The remotely controllable electronic device according to claim 1, further comprises a status indicating unit.

12. The remotely controllable electronic device according to claim 1, wherein the remotely controllable electronic device is a home appliance.

13. The remotely controllable electronic device according to claim 12, wherein the remotely controllable electronic device is a lamp, a fan, a stereo set, a washing machine or an oven.
